(19) United States
(12) Patent Application Publication
(10) Pub. No.: US 2005/0079371 A1
(43) Pub. Date: Apr. 14, 2005

(54) Method for manufacturing ceramic-like music instrument and ceramic-like material for forming music instruments by the same

(76) Inventor: Jean-Fung Guo, Taipei (TW)

Correspondence Address: JEAN-FUNG GUO, 235 Chung - Ho, Taipei, 8-24, TW

(21) Appl. No.: 10/684,242

(22) Filed: Oct. 8, 2003

(51) Int. Cl. B32B 15/04

(52) U.S. Cl. 428/469; 428/701; 428/702

(57) ABSTRACT

A method for manufacturing a ceramic-like music instrument comprises the steps of selecting a metal or metal alloy as a substrate of a music instrument; placing an auxiliary electrode in liquid; applied a voltage to a surface of the substrate and the auxiliary electrode so as to generate electric arc; the arc will gasify or ionize electrolyte nearby to generate plasma and thus generate an oxidizing film on the surface of the substrate,, wherein the oxidizing film is a ceramic like material. The electric arc generated on the surface of the substrate generates plasma so as to oxidize the auxiliary electrode. The oxidizing film completely different from the conventional anode. A ceramic-Like material for manufacturing a music instrument is selected from light metal and light metal alloy. A ceramic-like oxidizing film is coated on a surface of the metal or metal array.

### FIELD OF THE INVENTION

The present invention relates to manufacturing of music instruments, and particular to a method for manufacturing a ceramic-like music instrument and ceramic-like material for forming music instruments by the method,

### BACKGROUND OF THE INVENTION

Conventionally, the music instruments are aimed to increase the hardness of the material used, such as woods, metal or metal alloys, for example, copper, sliver, nickel, stainless steel, platinum, etc., so as to have preferred quality. This is because high hardness will make the reaction quick and thus sound can be clearly transferred with high efficiency vibration. Moreover, it is helpful for temperature tolerance and has a preferred stability to sound frequency. However, the conventional material for making music instruments has a hardness of about 100-200 Hv which cannot achieve the above said desired requirement.

Moreover, conventionally used metal or alloy music instruments must be welded in the manufacturing process so that the stress is non-uniform. As a result, the sound frequency is unstable.

Moreover, the metal used in the conventional music instruments, such as woods, metal or metal alloys, for example, copper, sliver, nickel, stainless steel, platinum, etc. is heavy. Thereby, the music instrument is compact, light and small size. Thereby, the burden on the user is decreased, but the vibration volume of the music instrument is reduced.

The manufacturing process of the conventional music instrument is complicated. In the following the manufacturing of flute is used as an example. FIG. 6 is a partial perspective view of the conventional flute, FIG. 7 is a cross section view thereof, the FIG. 8 is a front view of the keys of the flute, and FIG. 9 is a lateral cross section view of the flute. The tube body 7 includes a reb 61, a post 62, and a posthole 63. In the manufacturing process, the tube 6 is shaped, and then sound holes 64 are formed. The rib 61 is formed by punching and the post 62 is formed by lathe. Then the posthole 61 is formed by machining the key post. Then the post 62 and the reb 61 are welded by silver. Finally, the welded post 62 and reb 61 are tin-welded to the tube 6.

The key 7 includes an arm 71, a cup 72, a pipe 73, a press 74, an elastic hook 75. The processes of making the key increases the steps of forging, edge-cutting, bending, punching the cup 72, trimming, shaping and cutting the pipe 73, forging and cutting the press 74, lathing the elastic hook 75, silver-welding the pipe 73, press 74 and elastic hook 75 so as to complete the manufacturing of the press 7.

From above description, it is seen that the manufacturing process is complicated and a longer time is necessary. Thereby, the cost is high.

Moreover, the prior art music instruments have bad temperature tolerance. They easily deforms by temperature variation. Moreover, many places are welded so that the sound cannot be stablily transferred.

Thereby, it is know the prior art music instruments are not as good as desired ones. It is known that ceramic material has a preferred strength so as to overcome the above mentioned problem.

### SUMMARY OF THE INVENTION

Accordingly, the primary object of the present invention is to provide a method for manufacturing a ceramic-like music instrument.

Another object of the present invention is to provide a ceramic-like material for manufacturing a music instrument. the substrate of the music instrument according to the present invention is selected from light metal and the metal alloy and a ceramic-like oxidizing film is coated on a surface of the metal, or metal alloy.

The various objects and advantages of the present invention will be more readily understood from the following detailed description when read in conjunction with the appended drawing.

### BRIEF DESCRIPTION OF THE DRAWINGS

FIG. 1 is a perspective view of a flute extruded before further machining according to the present invention.

FIG. 2 is a perspective view of a flute extruded after further machining according to the present invention.

FIG. 3 is a perspective view of a flute keys extruded before further machining according to the present invention.

FIG. 4 is a perspective view of a flute keys extruded after further machining according to the present invention.

FIG. 5 shows the cross section view of an oxidizing film on a music instrument substrate.

FIG. 6 is a partial perspective view f a conventional flute main body.

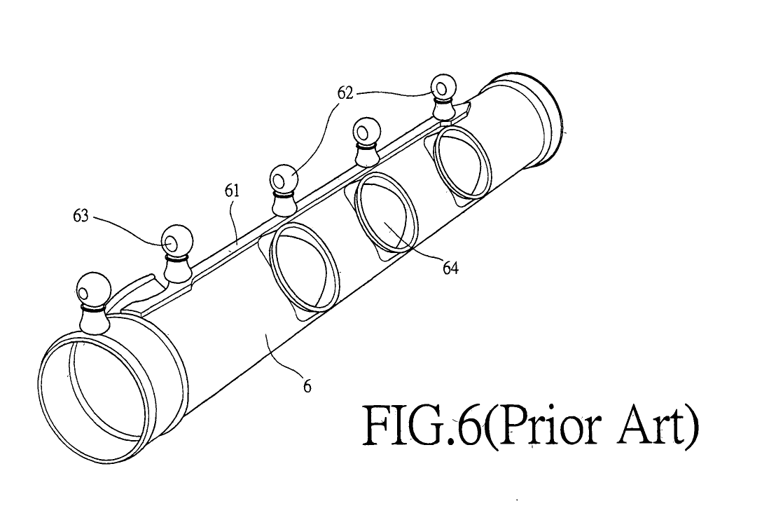

FIG. 7 is a cross section view of FIG. 6.

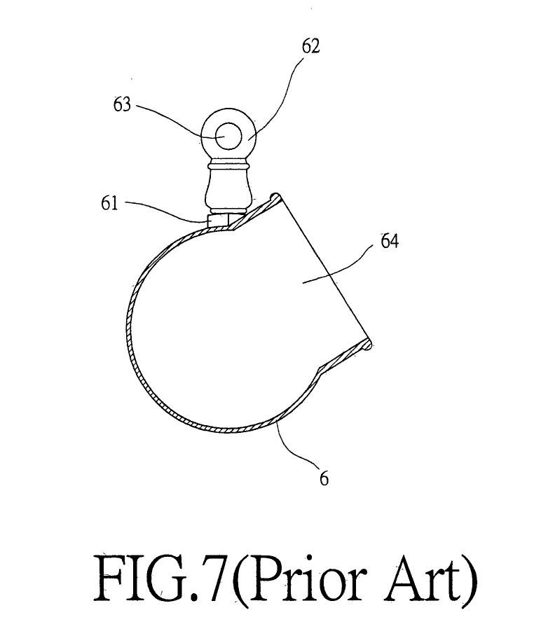

FIG. 8 is a front view of the keys of conventional flute.

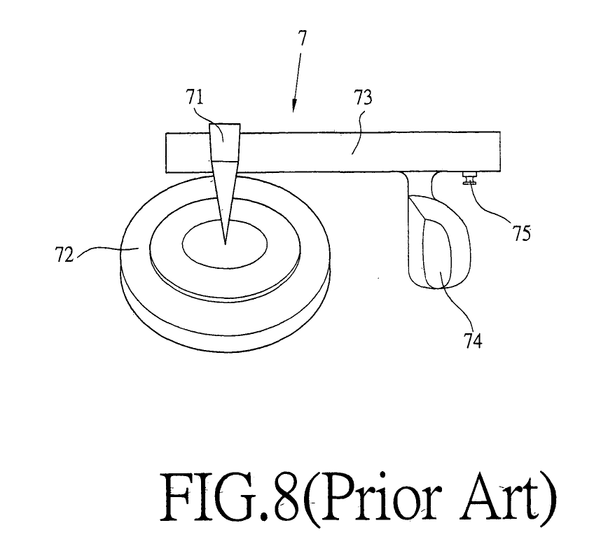

FIG. 9 is a side view of FIG. 8.

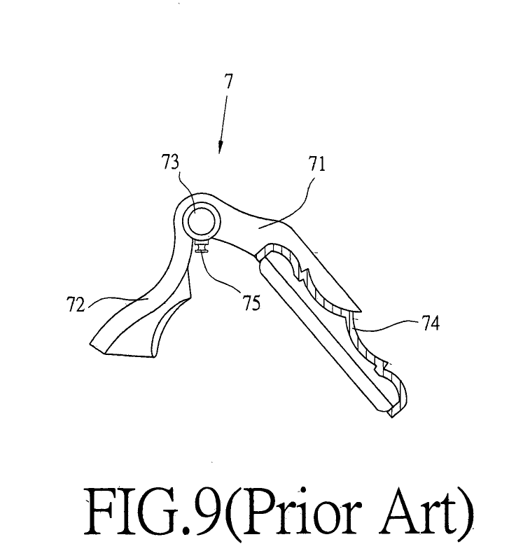

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

The preferred embodiment of embodiment will be described here.

The present invention provides a method for manufacturing a ceramic-like music instrument which comprises the following steps of selecting a light metal or a light metal alloy as a substrate of a music instrument; placing an auxiliary electrode in liquid; applied a voltage to a surface of the substrate and the auxiliary electrode so as to generate electric arc; gasifying or ionizing electrolyte nearby so as to generate plasma and thus generate an oxidizing film on the surface of the substrate.

In the present invention, the electric arc generated on the surface of the substrate of the music instrument generates plasma so as to oxidize the auxiliary electrode. Thereby, an oxidizing film is (ceramic-like material) completely different from the conventional anode. High temperature will melt the oxidizing film so as to change the holes of the oxidizing film and the microstructure of the oxidizing film.

In the present invention, the substrate of music instrument can be selected from one of aluminum, aluminum alloy, magnesium, magnesium alloy, titanium, titanium alloy, zirconium, zirconium alloy, cadmium, cadmium alloy, etc.

The following ways can be used to form the substrate of the music instrument.

1. Extrusion: an extruding tool is used to extrude the material of the substrate. A further machining work can be used to shape the substrate, this is especially suitable for aluminum, magnesium or the alloy thereof.

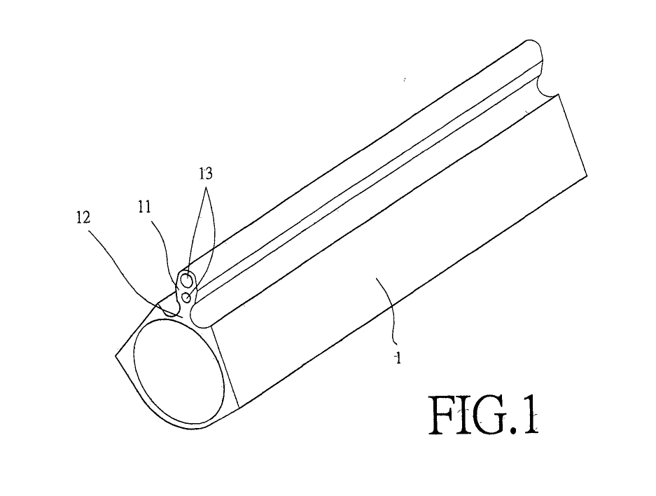

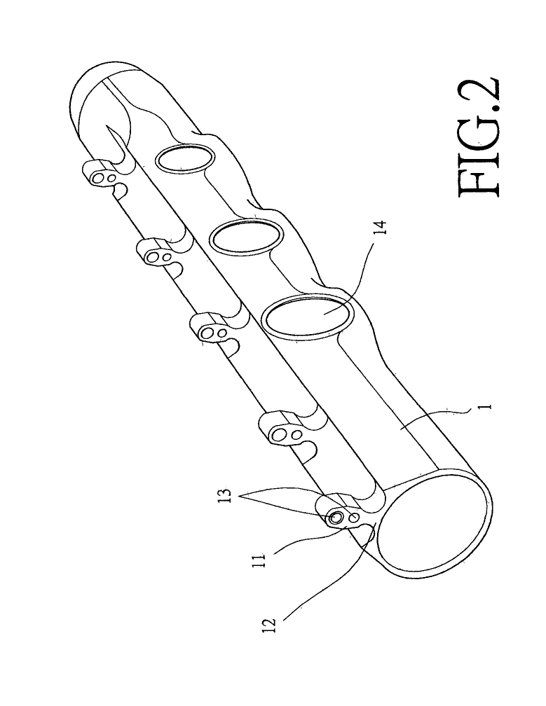

In the following, a method for manufacturing a flute is used as an embodiment for describing the present invention. A perspective view of the flute which is extruded and further machining by CNC is illustrated in FIG. 2. FIG. 1 shows the flute before machining. A tube body 1 extruded includes a post 11, a reb 12, a posthole 13, etc. (referring to FIG. 1). Then, a further machining work by CNC is used to compete a tube body 1 of the flute (referring to FIG. 2). The flute can be made rapidly.

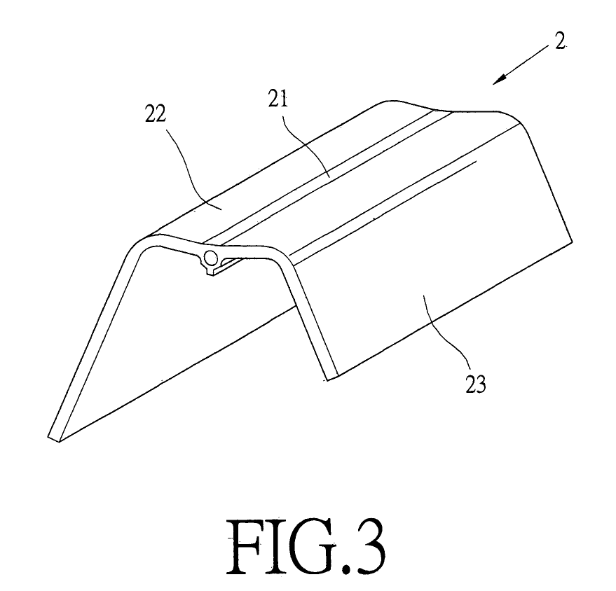

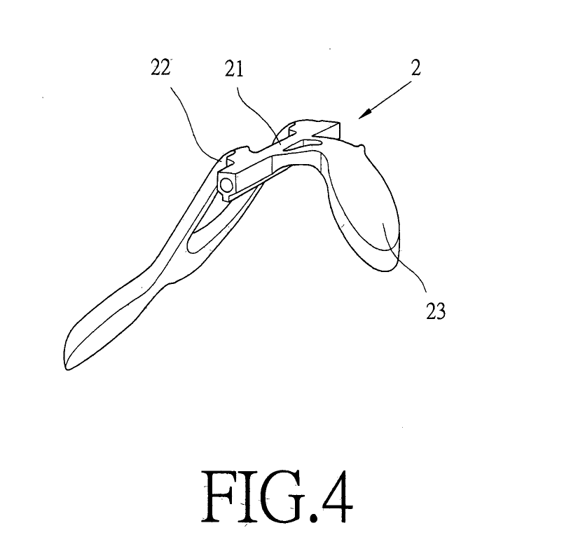

Besides, in FIG. 3, a perspective view of the model of an extruded flute before further machining is illustrated, and FIG. 4 shows the flute after machining by for example CNC. In FIG. 3, the key 2 includes a pipe 21, an arm 22, and a cup 23. The key is finished by CNC so as to form the key 2 shown in FIG. 4. The key can be made rapidly.

2. Mold injection: the aluminum, aluminum alloy, magnesium, magnesium alloy, etc., is melt and then is injected in mold so as to form a substrate of a predetermined music instrument. The key shows in FIGS. 2 and 4 can be made by the same way without any machining process.

3. Engraving: the material of such as aluminum, magnesium, titanium, etc., or the alloys thereof are engraved so as to form such as the tube body 1 including post 11, reb 12, post hole 13, and key 2 including the arm 22, pipe 21, cup 23 etc, so as to form the flute and key shown in FIGS. 2 and 4.

The tools used include CNC, line cutter, metal machining device, and other engraving tools.

The selection of above three methods is based on the shape of the music instrument. The combination of at least two of the three methods can be used.

The liquid above mentioned is mainly water, preferably pure water. Besides, to change the conductivity of the liquid, proper additives or purifying agent or other compounds can be added to the liquid.

When aluminum or aluminum alloy are used to make the substrate 3, a predetermined amount of alkaline silicic acid can be added so as to form low density alkaline silicic acid solution.

When the substrate of the music instrument is selected from magnesium or magnesium alloy. The liquid can be added with aluminum phosphate or aluminum mercaptide so as to form a film of Mg—Al—O.

The auxiliary electrode of the present invention is stainless. In general, it is placed in anode. In reaction, it provides current for Farady reaction. Thus almost no power lose generates.

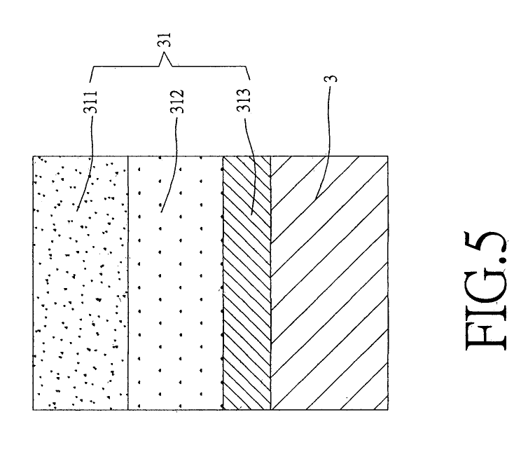

With reference to FIG. 5, by above method, the oxidizing film 31 on the substrate 3 of music instrument includes at least one layer of highly porous oxide ceramic layer 311, a slightly porous oxide ceramic layer 312 blew the highly porous oxide ceramic layer 311, and a barrier layer 313 below the slightly porous oxide ceramic layer 312. In the first highly porous oxide ceramic layer 311, hole density is high, and hardness is low. In the second layer, almost no hole is in the slightly porous oxide ceramic layer 312. The layer is high hardness and wear-proof. The hardness is about 500-2000 Hv. The third layer is an expansion layer.

The ceramic-like music instrument of the present invention has a high density and can prevent the temperature variation. Since the power lose of transmission of sound wave is low, the vibration and stability of sound frequency is high. Since light metal is used, the music instrument of the present invention is light. In the same weight, the volume of the music instrument can be increased for increasing the-resonance volume so as to have a preferred vibration effect. Moreover, by the ceramic-like music instrument of the present invention, the sound frequency band is widened.

The present invention can be used in various music instruments, such as flutes, piccolos, cornets, clarinets, oboes, bassoons, trumpet, keys of pianos, harmonica, violins, vibration films of trumpets, sound boxes, etc.

The present invention is thus described, it will be obvious that the same may be varied in many ways. Such variations are not to be regarded as a departure from -the spirit and scope of the present invention, and all such modifications as would be obvious to one skilled in the art are intended to be included within the scope of the following claims.

1. A method for manufacturing a ceramic-like music instrument which comprises the steps of:
selecting a metal or metal alloy as a substrate of a music instrument;
placing an auxiliary electrode in a liquid;
applied a potential to a surface of the substrate and the auxiliary electrode so as to generate electric arc; the arc will gasify or ionize electrolyte nearby so as to generate plasma and thus generate an oxidizing film on the surface of the substrate, wherein the oxidizing film is a ceramic like material.

2. The method for manufacturing a ceramic-like music instrument as claimed in claim 1, wherein the liquid is water or pure water.

3. The method for manufacturing a ceramic-like music instrument as claimed in claim 1, wherein to change the conductivity of the liquid, predetermined additives or purifying agents or other compounds are added to the liquid.

4. The method for manufacturing a ceramic-like music instrument as claimed in claim 1, wherein the substrate of music instrument is selected from one of aluminum, aluminum alloy, magnesium, magnesium alloy, titanium, titanium alloy, zirconium, zirconium alloy, cadmium alloy.

5. The method for manufacturing a ceramic-like music instrument as claimed in claim 4, wherein an extruding tool is used to extrude the material of the substrate and a further machining work is used to shape the substrate.

6. The method for manufacturing a ceramic-like music instrument as claimed in claim 5, wherein the machining work is performed by CNC.

7. The method for manufacturing a ceramic-like music instrument as claimed in claim 4, wherein the substrate is shaped by molding injection.

8. The method for manufacturing a ceramic-like music instrument as claimed in claim 4, wherein the substrate of the music instrument is performed by engraving.

9. The method for manufacturing a ceramic-like music instrument as claimed in claim 8, wherein the engraving is performed by CNC and/or line cutter.

10. The method for manufacturing a ceramic-like music instrument as claimed in claim 1, wherein an extruding tool is used to extrude the, material of the substrate and a further machining work is used to shape the substrate.

11. The method for manufacturing a ceramic-like music instrument as claimed in claim 10, wherein the machining work is performed by CNC.

12. The method for manufacturing a ceramic-like music instrument as claimed in claim 1, wherein the substrate is shaped by molding injection.

13. The method for manufacturing a ceramic-like music instrument as claimed in claim 1, wherein the substrate of the music instrument is performed by engraving.

14. The method for manufacturing a ceramic-like music instrument as claimed in claim 13, wherein the engraving is performed by CNC and/or line cutter.

15. The method for manufacturing a ceramic-like music instrument as claimed in claim 1, wherein when the substrate of the music instrument is selected from one of magnesium and magnesium alloy; the liquid is added with one of aluminum phosphate and aluminum mercaptide so as to form a film of Mg—Al—O.

16. The method for manufacturing a ceramic-like music instrument as claimed in claim 1, wherein when aluminum and aluminum alloy are used to make the substrate, a predetermined amount of alkaline silicic acid is added so as to form low density alkaline silicic acid solution.

17. The method for manufacturing a ceramic-like music instrument as claimed in claim 1, wherein the oxidizing film on the substrate of music instrument includes at least one layer of highly porous oxide ceramic layer, a slightly porous oxide ceramic layer blew the highly porous oxide ceramic layer, and a barrier layer below the slightly porous oxide ceramic layer.

18. The met-hod for manufacturing a ceramic-like music instrument as claimed in claim 1, wherein the hardness of the oxidizing film is about 500-2000 Hv.

19. A ceramic-like material for manufacturing an music instrument; the material being a, metal which is one of light metal and light metal alloy, a ceramic-like oxidizing film is coated on a surface of the metal or metal array.

20. The method for manufacturing a ceramic-like music instrument as claimed in claim 19, wherein the substrate of music instrument can be selected from one of aluminum, aluminum alloy, magnesium, magnesium alloy, titanium, titanium alloy, zirconium, zirconium alloy, cadmium alloy.

21. The method for manufacturing a ceramic-like music instrument as claimed in claim 19, wherein the oxidizing film on the substrate of music instrument includes at least one layer of highly porous oxide ceramic layer, a slightly porous oxide ceramic layer blew the highly porous oxide ceramic layer, and a barrier layer.

22. The method for manufacturing a ceramic-like music instrument as claimed in claim 19, wherein the hardness of the oxidizing film is about 500-2000 Hv.
